(19) United States
(12) Patent Application Publication
(10) Pub. No.: US 2008/0122149 A1
(43) Pub. Date: May 29, 2008

(54) HINGED MAGNETIC SUPPORT AND POSITIONING ASSEMBLY AND METHOD THEREOF

(75) Inventor: Ted Kegeris, Fairland, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: JVI Magnetics, Inc., Fountaintown, IN (US)

(21) Appl. No.: 11/876,215

(22) Filed: Oct. 22, 2007

Related U.S. Application Data
(60) Provisional application No. 60/862,377, filed on Oct. 20, 2006.

(51) Int. Cl. B25B 11/00; B23Q 3/15; H01F 7/00

(52) U.S. Cl. 269/8; 269/9; 335/285

(57) ABSTRACT

A hinged magnetic assembly including at least two rotatable magnets and at least two arms used to secure the magnets and define a distance between the magnets, locking bolts to prevent rotation of the magnets and lock the magnets in a predetermined orientation, the hinged magnet assembly used to facilitate connecting construction elements together.

### CROSS-REFERENCE TO RELATED APPLICATION

This application claims priority of U.S. Provisional Patent Application No. 60/862,377, filed on Oct. 20, 2006, in the United States Patent & Trademark Office, the disclosure of which is incorporated herein by reference in its entirety.

### BACKGROUND OF THE INVENTION

1. Field of the Invention

The present general inventive concept relates to a hinged magnetic support and positioning assembly and method thereof, and more particularly, to an assembly having at least two industrial strength magnets connected by a hinge to support and position elements during construction.

2. Description of the Related Art

Construction applications generally involve connecting various pieces of material together. Some applications involve very large pieces of material and/or pieces of material having awkward shapes. Such pieces present a user with significant difficulty with respect to maneuvering the pieces prior to joining. This process is further aggravated if the pieces must be joined at precise points with little or no tolerance for error.

Convention methods generally require a user and several assistant users to assist with maneuvering and joining large and/or awkward pieces of material. As such, conventional methods present a difficult process, require additional manpower, and are therefore inefficient.

Also involved in construction applications is a variety of construction equipment, some of which is required to be secured in place during use. One such piece of equipment is a hole former, which is used in the Precast Industry to create a hole for pipes to enter manholes. Manholes range in diameter from 4′ to over 10′ with varying depths.

Convention methods either bolt the hole former to a steel core of the manhole or shell, or position and tie the hole former to steel wire mesh, which is around the core. Both methods are time consuming, requiring the user to spend extra time attaching and detaching the hole former. Other disadvantages of these methods include that the hole former and steel core must both be pre-drilled with a bolt hole, which lowers the mechanical integrity of both. Further, tying the hole former does not present a secure means of engagement.

### SUMMARY OF THE INVENTION

A principal object of the present general inventive concept is to provide a hinged magnetic assembly having a plurality of industrial strength magnets.

Another object of the present general inventive concept is to provide at least two industrial strength magnets connected by a hinge capable of holding construction elements in a desired orientation.

Another object of the present general inventive concept is to provide at least two industrial strength magnets connected by a hinge capable of holding utility hole formers in place.

The foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a hinged magnet illustrating an exemplary embodiment of the present general inventive concept showing two magnet assemblies (one of which is a cam magnet) attached to two arms such that an angle is formed between the magnet assemblies.

FIG. 2 is a picture of the hinged magnet of FIG. 1 showing a side view of two different magnet assemblies coupled with two arms and bolted into a set angle position.

FIG. 3 is a picture of the hinged magnet of FIG. 1 showing two magnet assemblies (one of which is a cam magnet) coupled to two arms such that an angle is formed between the magnet assemblies.

FIG. 4 is a picture of the hinged magnet of FIG. 1 showing two magnet assemblies (one of which is a cam magnet) coupled to two arms such that an angle is formed between the magnet assemblies.

FIG. 5 is a picture of the hinged magnet illustrating an exemplary embodiment of the present general inventive concept showing two matching magnet assemblies coupled to two arms such that an angle if formed between the magnet assemblies.

FIG. 6 is a picture of the hinged magnet of FIG. 5 showing the hinged magnet attached to a steel plate.

FIG. 7 is a picture of the hinged magnet of FIG. 5 showing the hinged magnet in use.

FIG. 8 is a picture of the hinged magnet of FIG. 1 showing the hinged magnet in use.

FIG. 9 is a picture of the hinged magnet of FIG. 5 showing the hinged magnet in use.

FIG. 10 is a picture of the hinged magnet of FIG. 1 showing the hinged magnet in use.

FIG. 11 is a picture of the hinged magnet of FIG. 1 showing the hinged magnet in use.

FIG. 12 is a drawing of the hinged magnet of FIG. 5 showing the various dimensions of one embodiment.

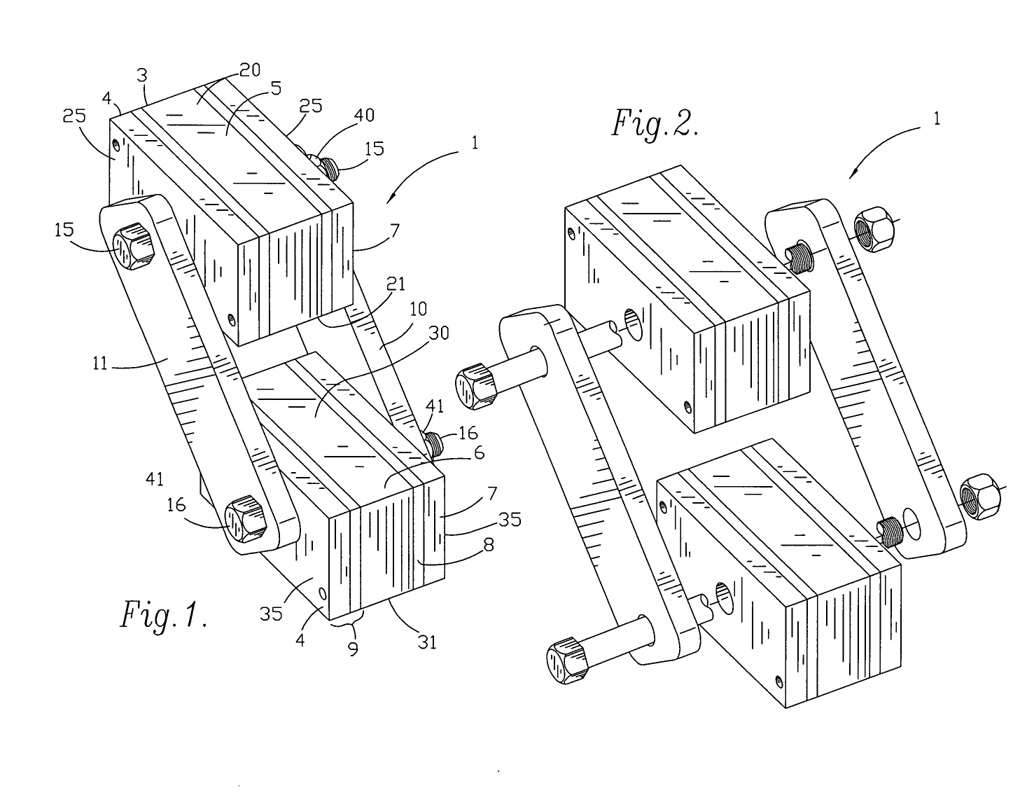

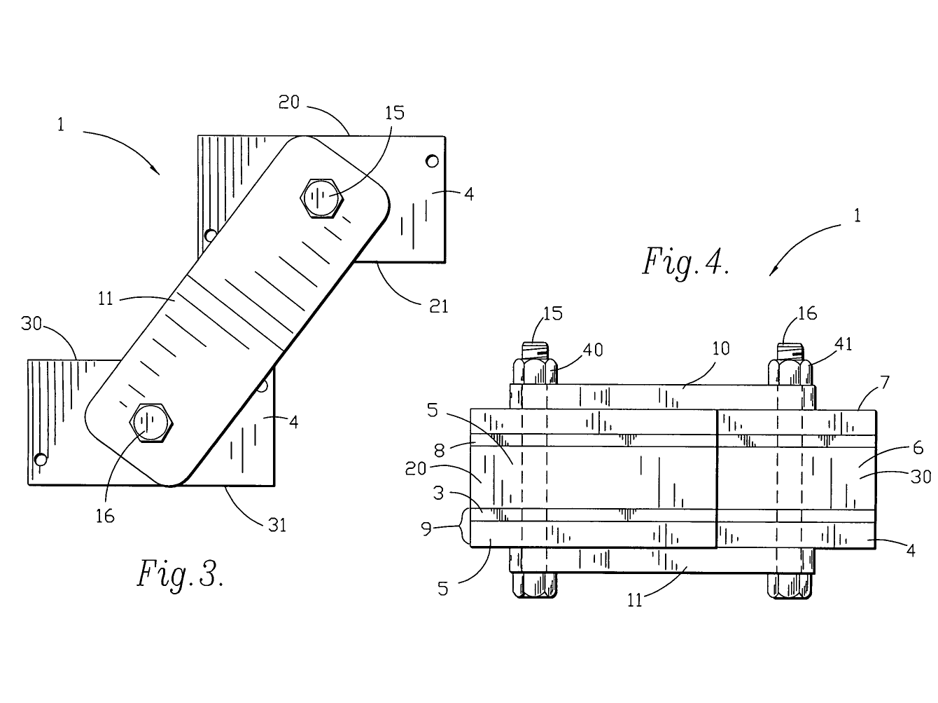

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept be referring to the figures.

FIG. 1 illustrates a hinged magnet assembly 1 including at least one magnet 5 of industrial strength coupled with at least one other magnet 6 of industrial strength. The magnets 5 and 6 are respectively sandwiched between attachment layers 3 and 8 to respectively secure the magnets 5 and 6 to outer plates 4 and 7. The magnets 5 and 6 can be cam magnets with notched or floating sides, flat magnets, or any other like magnets.

The outer plates 4 and 7 and attachment layers 3 and 8 coordinate to provide a buffer zone 9 between the magnets 5 and 6 and arms 10 and 11. The buffer zone 9 prevents the magnets 5 and 6 from interfering with movement of the arms 10 and 11, and provides increased magnetization in a desired direction, i.e., on a top face surface 20 and 30 or a bottom face surface 21 and 31 of the magnets 5 and 6.

The two arms 10 and 11 of the hinged magnet assembly 1 engage the magnets 5 and 6 at respective side surfaces 25 and 35. The two arms 10 and 11 connect the magnets 5 and 6 to each other with each magnet 5 and 6 having a point of rotation 15 and 16.

In the preferred embodiment, the magnets 5 and 6 are identically sized and shaped. However, the magnets 5 and 6 may be sized and shaped differently depending on factors such as, but not limited to, the intended application of the magnets 5 and 6.

The arms 10 and 11 hold the two magnets 5 and 6 together and are coupled to define a specific range of motion with respect to rotation of the magnets 5 and 6. The range of motion allows either or both magnets 5 and 6 to independently rotate around the points of rotation 15 and 16 with respect to each other.

Lock bolts 40 and 41 may be used to secure either or both magnets 5 and 6 at desired orientations with respect to each other to allow a user to configure the magnet assembly 1 to facilitate its use in a specific application. The length, width, height, and magnetic strength as well as desired orientation of the magnets 5 and 6 will vary from one application to another.

In use, the magnets 5 and 6 are positioned in a desired orientation and positioned between two steel parts (not illustrated) that are to be joined. Upon position the magnets 5 and 6, the lock bolts 40 and 41 can be tightened to lock the magnets 5 and 6 at the desired angle to avoid inadvertent repositioning during use, e.g., upon engagement with the steel parts.

The hinged magnet assembly 1 holds the steel parts in place to facilitate engagement of the steel parts via soldering, welding, bonding, or the like. The steel parts can be held in any position, e.g., in contact with each other or with space therebetween.

The hinged magnet assembly 1 allows for less movement during bonding. If the two steel pieces are above the head of the user pre-engagement, it is advantageous to be able to securely position the pieces.

The hinged magnet assembly 1 may be used for many applications, including, but not limited to use with utility plant products, including manholes, catch basins, and another other applications where two steel parts are to be joined together.

In another embodiment, the hinged magnet assembly 1 may be used with a utility hole former. The hole former is a large diameter hole former used in the precast industry to create a hole for pipes to enter a manhole. Manholes range in diameter from 4′ to 10′ plus and come in various heights.

It is known in the precast industry to either bolt the hole former to the steel core or shell and tie to it steel wire mesh which is around the core. The hinged magnet assembly 1 may be used to hold the hole former in place. The hole former is made of steel or other metal material that is attached to magnets 5 and 6. One magnet 5 and 6 of the hinged magnet assembly 1 attaches to the steel of the hole former and the other magnet 5 and 6 assembly of the hinged magnet assembly 1 is placed in position on the core or shell.

Several advantages of the present general inventive concept for use with hole formers is that the hinged magnet assembly 1 provides flexibility for placement without putting holes in the core or jacket.

The hinged magnet assembly 1 also provides for less movement than attaching to steel wire mesh. The use of the hinged magnet assembly 1 eliminates the need for holes in forms and eliminates the movement of floating hole formers.

Having now described the features, discoveries and principles of the general inventive concept, the manner in which the general inventive concept is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A hinged magnetic assembly comprising:
at least two magnets; and
at least two arms,
wherein the arms secure the magnets thereby defining a distance between the magnets, and allow rotation of at least one of the magnets with respect to the other.

2. The hinged magnetic assembly according to claim 1, further comprising:
a plurality of connection layers, one on either side of the magnets; and
a plurality of outer plates, one on either side of the connection layer,
wherein the plurality of connection layers join the magnets to the plurality of outer plates.

3. The hinged magnetic assembly according to claim 2, wherein the plurality of connection layers are adhesive layers.

4. The hinged magnetic assembly according to claim 1, wherein the plurality of connection layers and the plurality of outer plate layers are configured to define a magnetic focal direction.

5. The hinged magnetic assembly according to claim 1, wherein the plurality of connection layers and the plurality of outer plate layers are configured to provide a buffer zone between the magnets and the at least two arms.

6. The hinged magnetic assembly according to claim 1, wherein the distance between the magnets is a set distance.

7. The hinged magnetic assembly according to claim 1, wherein the distance between the magnets is a set distance.

8. The hinged magnetic assembly according to claim 1, further comprising:
an axis of rotation on either end of the at least two arms,
a bar connecting the at least two arms via passing between one axis of rotation on one of the at least two arms and engaging a second axis of rotation on another of the at least two arms.

9. The hinged magnetic assembly according to claim 1, wherein the at least two arms permit rotation of one or both of the magnets.

10. The hinged magnetic assembly according to claim 9, further comprising:
one or more lock bolts to enable locking engagement of the at least two arms with one or both magnets to prevent rotation of one or both magnets in a desired orientation.

11. The hinged magnetic assembly according to claim 1, further comprising:
one or more lock bolts to enable locking engagement of the at least two arms with one or both magnets to secure one or both magnets in a desired orientation.

12. A method of using a hinged magnetic assembly comprising:
providing two rotatable magnets that are connected to each other by at least two arms;
locking a first one of the two rotatable magnets in a predetermined orientation with respect to the at least two arms;
magnetically connecting the first one the two rotatable magnets to a first construction element and magnetically connecting a second one of the two rotatable magnets to a second construction element;
moving the second one of the two rotatable magnets into a predetermined orientation with respect to the first one of the two rotatable magnets; and
joining the first and second construction elements together.
